(19) United States
(12) Patent Application Publication
(10) Pub. No.: US 2017/0341026 A1
(43) Pub. Date: Nov. 30, 2017

(54) Vanadium Catalysts for High Engine-Out NO2 Systems

(71) Applicant: Johnson Matthey Public Limited Company, London (GB)

(72) Inventors: Hai-Ying Chen, Wayne, PA (US); Julian Cox, Wayne, PA (US); Joseph Fedeyko, Wayne, PA (US); Penelope Markatou, Audubon, PA (US); Jason Pless, Audubon, PA (US)

(21) Appl. No.: 15/608,276

(22) Filed: May 30, 2017

Related U.S. Application Data
(60) Provisional application No. 62/343,224, filed on May 31, 2016.

(51) Int. Cl. B01D 53/94; F01N 3/08; F01N 11/00; B01J 23/22

(52) U.S. Cl. CPC B01D 53/9418; B01J 23/22; F01N 3/0814; F01N 3/0842; F01N 11/002; B01D 2255/20723; B01D 2255/904; B01D 2255/91; B01D 2255/915; F01N 2610/02

(57) ABSTRACT

An exhaust gas purification system for lowering the content of impurities in a lean exhaust gas of an internal combustion engine comprising, a feeding device that feeds ammonia or a compound decomposable to ammonia into an exhaust gas stream containing nitrogen oxides; a selective catalytic reduction catalyst comprising vanadium (V-SCR catalyst) which catalyzes the nitrogen oxides with ammonia in a temperature range of about 150° C. to about 400° C. and at an NO₂/NOₓ ratio of about 0.3 to about 0.9; and a downstream system comprising a diesel oxidation catalyst.

### BACKGROUND

In the past, N₂O has been an unregulated vehicle emission. However, recent studies have shown that N₂O can contribute significantly to global warming with a potential for increased warming which is 298 times greater than CO₂ over a 100 year period. New regulations targeting stricter limits on greenhouse gas emissions from on-road vehicles will include legislation on N₂O release. One solution has been to run the engine at colder temperatures. This is a problem for certain engine designs and calibrations because at colder temperatures, a significant portion of the NOx emitted from the engine is as NO₂. When the mixture of NO and NO₂ comes in contact with an oxidation catalyst in the presence of hydrocarbons (“HC”), the resulting HC-SCR reaction over platinum group metal (“PGM”) salts primarily results in N₂O formation, and the system will fail emissions.

### SUMMARY OF THE INVENTION

According to some embodiments of the present invention, an exhaust gas purification system for lowering the content of impurities in a lean exhaust gas of an internal combustion engine includes, in combination and in order: a feeding device that feeds ammonia or a compound decomposable to ammonia into an exhaust gas stream containing nitrogen oxides; a selective catalytic reduction catalyst comprising vanadium (V-SCR catalyst) which catalyzes the nitrogen oxides with ammonia in a temperature range of about 150° C. to about 400° C. and at an NO₂/NOₓ ratio of about 0.3 to about 0.9; and a downstream system comprising a diesel oxidation catalyst. The V-SCR catalyst may be coupled with, for example, a hydrolysis catalyst located upstream of the V-SCR catalyst, and/or with an ammonia slip catalyst located downstream of the V-SCR catalyst. In some embodiments, the system may include a turbocharger located downstream of the feeding device and/or downstream of the V-SCR catalyst. In some embodiments, the downstream system is effective for removing pollutants from the exhaust gas in a temperature range of about 150° C. to about 400° C. In some embodiments, the diesel oxidation catalyst oxidizes pollutants from the exhaust gas in a temperature range of about 150° C. to about 400° C. The downstream system may include one or more of an ammonia slip catalyst, a filter, a NOx storage catalyst, a three-way catalyst, one or more additional diesel oxidation catalysts, an injector for ammonia or a compound decomposable to ammonia, and/or a selective catalytic reduction catalyst. In some embodiments, the downstream system includes a secondary fuel injector upstream of the diesel oxidation catalyst. The downstream system may include a catalyzed soot filter. In a particular example, the downstream system includes, in order, an ammonia slip catalyst, a diesel oxidation catalyst, a catalyzed soot filter, and a selective catalytic reduction catalyst. In a particular example, the downstream system includes, in order, an ammonia slip catalyst, a diesel oxidation catalyst, an SCRF, and a selective catalytic reduction catalyst.

According to some embodiments of the present invention, an exhaust gas purification system for lowering the content of impurities in a lean exhaust gas of an internal combustion engine, the exhaust gas having an NO₂/NOₓ ratio of about 0.3 to about 0.9, includes: a feeding device that feeds ammonia or a compound decomposable to ammonia into an exhaust gas stream containing nitrogen oxides; a selective catalytic reduction catalyst comprising vanadium (V-SCR catalyst); a turbocharger downstream of the feeding device and/or the V-SCR catalyst; a secondary fuel injector; and a downstream system comprising a diesel oxidation catalyst. The downstream system may further include one or more of an ammonia slip catalyst, a filter, a NOx storage catalyst, a three-way catalyst, one or more additional diesel oxidation catalysts, an injector for ammonia or a compound decomposable to ammonia, and/or a selective catalytic reduction catalyst. In some embodiments, the downstream system includes a catalyzed soot filter. In a particular example, the downstream system includes, in order, an ammonia slip catalyst, a diesel oxidation catalyst, a catalyzed soot filter, and a selective catalytic reduction catalyst. In a particular example, the downstream system includes, in order, an ammonia slip catalyst, a diesel oxidation catalyst, an SCRF, and a selective catalytic reduction catalyst. The downstream system may be effective for removing pollutants from the exhaust gas in a temperature range of about 150° C. to about 400° C. In some embodiments, the diesel oxidation catalyst oxidizes pollutants from the exhaust gas in a temperature range of about 150° C. to about 400° C. The V-SCR catalyst may be coupled with a hydrolysis catalyst located upstream of the V-SCR catalyst, and/or with an ammonia slip catalyst located downstream of the V-SCR catalyst.

According to some embodiments of the present invention, an exhaust gas purification system for lowering the content of impurities in a lean exhaust gas of an internal combustion engine includes, in combination and in order: a first reductant feeding device that feeds ammonia or a compound decomposable to ammonia into an exhaust gas stream containing nitrogen oxides; a selective catalytic reduction catalyst comprising vanadium (V-SCR catalyst) which catalyzes the nitrogen oxides with ammonia in a temperature range of about 150° C. to about 400° C. and at an NO₂/NOₓ ratio of about 0.3 to about 0.9; and a cold start catalyst. The exhaust gas purification system may further include a second, downstream reductant feeding device that feeds ammonia or a compound decomposable to ammonia into the exhaust gas stream. In some embodiments, the cold start catalyst includes a passive NOx absorber such as a passive NOx absorber including zeolite and Pd. The cold start catalyst may be effective to adsorb NOₓ and hydrocarbons (HC) at or below a low temperature and to convert and release the adsorbed NOₓ and HC at temperatures above a low temperature. In some embodiments, the cold start catalyst is effective to adsorb NOₓ at or below a low temperature and to release the adsorbed NOₓ at temperatures above a low temperature. In some embodiments, the low temperature is about 200° C. The system may further include a downstream system including one or more of an ammonia slip catalyst, a filter, an oxidation catalyst, an injector for ammonia or a compound decomposable to ammonia, and/or a selective catalytic reduction catalyst. In some embodiments, the downstream system is effective for removing pollutants from the exhaust gas in a temperature range of about 150° C. to about 400° C. The system may further include a secondary fuel injector. In some embodiments, the V-SCR catalyst is coupled with a hydrolysis catalyst located upstream of the V-SCR catalyst and/or with an ammonia slip catalyst located downstream of the V-SCR catalyst.

According to some embodiments of the present invention, an exhaust gas purification system for lowering the content of impurities in a lean exhaust gas of an internal combustion engine, the exhaust gas having an NO₂/NOₓ ratio of about 0.3 to about 0.9, includes: a first reductant feeding device that feeds ammonia or a compound decomposable to ammonia into an exhaust gas stream containing nitrogen oxides; a selective catalytic reduction catalyst comprising vanadium (V-SCR catalyst); and a cold start catalyst. The system may further include a second reductant feeding device that feeds ammonia or a compound decomposable to ammonia into an exhaust gas stream containing nitrogen oxides. The system may include a downstream system comprising a diesel oxidation catalyst. In some embodiments, the system includes downstream system further comprising one or more of an ammonia slip catalyst, a filter, one or more additional diesel oxidation catalysts, an injector for ammonia or a compound decomposable to ammonia, and/or a selective catalytic reduction catalyst. In a particular embodiment, the system includes a secondary fuel injector. The cold start catalyst may include a passive NOx absorber such as a passive NOx absorber including zeolite and Pd. In some embodiments, the cold start catalyst is effective to adsorb NOₓ and hydrocarbons (HC) at or below a low temperature and to convert and release the adsorbed NOₓ and HC at temperatures above a low temperature. In some embodiments, the cold start catalyst is effective to adsorb NOₓ at or below a low temperature and to release the adsorbed NOₓ at temperatures above a low temperature. The low temperature may be about 200° C. In some embodiments, the downstream system is effective for removing pollutants from the exhaust gas in a temperature range of about 150° C. to about 400° C. The V-SCR catalyst may be coupled with a hydrolysis catalyst located upstream of the V-SCR catalyst and/or coupled with an ammonia slip catalyst located downstream of the V-SCR catalyst.

According to some embodiments of the present invention, a method of treating diesel engine exhaust gases in an exhaust system containing nitrogen oxides, includes: (a) adding ammonia or a compound decomposable to ammonia into the exhaust gas stream containing nitrogen oxides; (b) passing the exhaust gas stream containing nitrogen oxides, with an NO₂/NOₓ ratio of about 0.3 to about 0.9, over a selective catalytic reduction catalyst including vanadium (V-SCR catalyst) which catalyzes the nitrogen oxides with ammonia in a temperature range of about 150° C. to about 400° C.; and (c) passing the exhaust gas through a downstream system including a diesel oxidation catalyst. In some embodiments, the method includes passing the exhaust gas stream through a turbocharger after step (a) and/or after step (b). The downstream system may remove pollutants from the exhaust gas in a temperature range of about 150° C. to about 400° C., and/or the diesel oxidation catalyst may oxidize pollutants from the exhaust gas in a temperature range of about 150° C. to about 400° C. In some embodiments, the downstream system includes one or more of an ammonia slip catalyst, a filter, a NOx storage catalyst, a three-way catalyst, one or more additional diesel oxidation catalysts, an injector for ammonia or a compound decomposable to ammonia, a selective catalytic reduction catalyst, and/or a catalyzed soot filter. The system may include, for example, a secondary fuel injector upstream of the diesel oxidation catalyst. In a particular embodiment, the downstream system includes, in order, an ammonia slip catalyst, a diesel oxidation catalyst, a catalyzed soot filter, and a selective catalytic reduction catalyst. In a particular embodiment, the downstream system includes, in order, an ammonia slip catalyst, a diesel oxidation catalyst, an SCRF, and a selective catalytic reduction catalyst. In some embodiments, the amount of ammonia or of a compound decomposable to ammonia added to the exhaust gas stream in (a) is selected so that the exhaust gas stream has an NH₃/NOx ratio of about 0.1 to about 0.7. The V-SCR catalyst may be coupled with a hydrolysis catalyst located upstream of the V-SCR catalyst and/or coupled with an ammonia slip catalyst located downstream of the V-SCR catalyst. The V-SCR catalyst may achieve a NOx conversion of about 60% to about 80%, depending on NH₃/NOx ratio.

According to embodiments of the present invention, a method of treating diesel engine exhaust gases in an exhaust system containing nitrogen oxides includes: (a) adding ammonia or a compound decomposable to ammonia into the exhaust gas stream containing nitrogen oxides; (b) passing the exhaust gas stream containing nitrogen oxides, with an NO₂/NOₓ ratio of about 0.3 to about 0.9, over a selective catalytic reduction catalyst including vanadium (V-SCR catalyst) which catalyzes the nitrogen oxides with ammonia in a temperature range of about 150° C. to about 400° C.; and (c) passing the exhaust stream over a cold start catalyst. In some embodiments, the method includes passing the exhaust gas stream through a turbocharger after step (a) and/or after step (b). The method may also include passing the gas through a downstream system including one or more of an ammonia slip catalyst, a filter, an oxidation catalyst, an injector for ammonia or a compound decomposable to ammonia, and/or a selective catalytic reduction catalyst. The downstream system may be effective for removing pollutants from the exhaust gas in a temperature range of about 150° C. to about 400° C. The downstream system may include a diesel oxidation catalyst which oxidizes pollutants from the exhaust gas in a temperature range of about 150° C. to about 400° C. The downstream system may include a secondary fuel injector upstream of the diesel oxidation catalyst. In some embodiments, the amount of ammonia or of a compound decomposable to ammonia added to the exhaust gas stream in step (a) is selected so that the exhaust gas stream has an NH₃/NOx ratio of about 0.1 to about 0.7. In some embodiments, the method includes adding ammonia or a compound decomposable to ammonia into the exhaust gas stream containing nitrogen oxides downstream of the cold start catalyst, so that the exhaust gas stream has an NH₃/NOx ratio of about 0.8 to about 1. The method may include adsorbing NOₓ and HC onto the cold start catalyst below a low temperature, and converting and thermally desorbing NOₓ and HC from the cold start catalyst at temperatures above the low temperature. The method may include adsorbing NOₓ onto the cold start catalyst below a low temperature, and thermally desorbing NOₓ from the cold start catalyst at temperatures above the low temperature. In some embodiments, the low temperature is about 200° C. The V-SCR catalyst may be coupled with a hydrolysis catalyst located upstream of the V-SCR catalyst and/or is coupled with an ammonia slip catalyst located downstream of the V-SCR catalyst.

In some embodiments, the V-SCR catalyst achieves a NOx conversion of about 60% to about 80%.

### BRIEF DESCRIPTION OF THE DRAWINGS

FIG. 1 shows NOx conversion by different catalysts at varying levels NO₂% of NOx.

### DETAILED DESCRIPTION

Methods and systems of the present invention relate to purification of an exhaust gas from an internal combustion engine. The invention is particularly directed to cleaning of an exhaust gas from a diesel engine, especially engines in vehicles, which often start with a cold engine and cold exhaust gas system.

It has been found that use of a vanadium selective catalytic reduction (“SCR”) catalyst (“V-SCR catalyst”) according to the present invention may address issues related to N₂O emissions, particularly during cold starts and in cold exhaust gas systems, as well as provide additional benefits. Vanadium-containing SCR catalysts have historically been avoided for cleaning exhaust gases from motor vehicles because of the possible emission of volatile, toxic vanadium compounds at higher exhaust gas temperatures, with potentially harmful effects on humans and the environment. Accordingly, there has been low interest in vanadium-containing car exhaust catalysts.

V-SCR catalysts have previously been proposed as an upstream catalytic component for stationary systems, but typically in low NO₂ streams with less than 40% NO₂ fractions. To function properly for a high engine out NO₂ system, a suitable catalyst is required to have a high conversion at NO₂ fractions greater than 40% and at low temperatures. These characteristics are desirable as they help to prevent NO₂ slip to a downstream diesel oxidation catalyst (“DOC”) under conditions where the downstream catalyst would be active for HC-SCR. Surprisingly, it has been found that V-based formulations achieve higher conversions under these conditions (high-NO₂ on-road engine out conditions) than traditional state of the art Fe or Cu SCR catalyst.

V-SCR catalysts also partially oxidize hydrocarbons to CO. This is beneficial in reducing the hydrocarbon in the exhaust that passes over the downstream oxidation catalyst. Furthermore, the CO produced over the V-SCR will help with the NOx storage of a NOx storage device, if present.

### SCR/V-SCR

A selective catalytic reduction (“SCR”) catalyst is a catalyst that reduces NOx to N₂ by reaction with nitrogen compounds (such as ammonia or urea) or hydrocarbons (lean NOx reduction). SCR catalysts may be comprised of a vanadium-titania catalyst, a vanadium-tungsta-titania catalyst, or a transition metal/molecular sieve catalyst.

SCR catalysts containing vanadium (V-SCR catalysts), may include vanadium on TiO₂ support or hybrid catalysts including vanadium on TiO₂ with Fe-zeolite or bare zeolite components blended in a formulation.

A V-SCR catalyst may include vanadium as free vanadium, vanadium ion, or an oxide of vanadium or a derivative thereof. In addition to vanadium, the catalyst can include other metal oxides such as oxides of tungsten, oxides of nobium, and/or oxides of molybdenum. As used herein, a “catalytically active” metal oxide is one that directly participates as a molecular component in the catalytic reduction of NOₓ and/or oxidization of NH₃or other nitrogenous-based SCR reductants. By corollary, a “catalytically inactive” metal oxide is one which does not directly participate as a molecular component in the catalytic reduction of NOₓ and/or oxidization of NH₃or other nitrogenous-based SCR reductants. In certain embodiments, an oxide of vanadium is present in a majority amount relative to other catalytically active metal oxides, such as tungsten oxides. In certain other embodiments, oxides of vanadium are present in a minority amount relative to other catalytically metal oxides, such as tungsten oxides.

In certain embodiments, the support material for the vanadium component is titania or titania in combination with another component such as tungsten (VI) oxide, molybdenum oxide, or silica as a mixture or as a mixed oxide. The support material may be aluminosilicate, alumina, silica, and/or titania doped with silica. While both vanadium and the support can both be metal oxides, the two components are structurally distinct from each other in that the support is present as discrete particles and the vanadium is present in a relatively thin layer or coating that adheres to the particles. Thus, the vanadium and titania are not present as a mixed oxide.

The mean particle size, based on the particle count, of the support material is preferably about 0.01-10 μm, for example about 0.5-5 μm, about 0.1-1 μm, or about 5-10 μm, and preferably has a majority of the particle count within one of these ranges. In other embodiments, the high surface area support is an aluminosilicate, silico-aluminophosphate, or aluminophosphate molecular sieve, such as a zeolite, preferably having a framework of BEA, MFI, CHA, AEI, LEV, KFI, MER, RHO, or ERI, or an intergrowth of two or more of these.

The transition metal/molecular sieve catalyst comprises a transition metal and a molecular sieve, such as an aluminosilicate zeolite or a silicoaluminophosphate. The transition metal may be selected from chromium, cerium, manganese, iron, cobalt, nickel, and copper, and mixtures thereof. Iron and copper may be particularly preferred. The molecular sieve may comprise a beta zeolite, a faujasite (such as an X-zeolite or a Y-zeolite, including NaY and USY), an L-zeolite, a ZSM zeolite (e.g. ZSM-5, ZSM-48), an SSZ-zeiolite (e.g., SSZ-13, SSZ-41, SSZ-33), a ferrierite, a mordenite, a chabazite, an offretite, an erionite, a clinoptilolite, a silicalite, an aluminum phosphate zeolite (including a metalloaluminophosphate, such as SAPO-34), a mesoporous zeolite (e.g., MCM-41, MCM-49, SBA-15), or mixtures thereof. An SCR catalyst may include a metal/zeolite catalyst such as iron/beta zeolite, copper/beta zeolite, copper/SSZ-13, copper/SAPO-34, Fe/ZSM-5, or copper/ZSM-5. Preferably, the molecular sieve may comprise a beta zeolite, a ferrierite, or a chabazite. Preferred SCR catalysts include Fe—CHA, Fe—AEI, Mn—CHA, Mn—BEA, Mn—FER, Mn—MFI, Cu—CHA, such as Cu—SAPO—34, Cu—SSZ—13, and Fe-Beta zeolite.

A selective catalytic reduction catalyst may be used with a filter, referred to as an SCRF. Selective catalytic reduction filters (SCRF) are single-substrate devices that combine the functionality of an SCR and a particulate filter. They may be used to reduce NOₓ as well as particulate emissions from internal combustion engines. In addition to the SCR catalyst coating, the particulate filter may also include other metal and metal oxide components (such as Pt, Pd, Fe, Mn, Cu, and ceria) to oxidize hydrocarbons and carbon monoxide in addition to destroying soot trapped by the filter. Systems of the present invention may include SCRF catalysts comprising a vanadium catalyst, referred to herein as a V-SCRF catalyst. References to use of the V-SCR catalyst throughout this application are understood to include use of the V-SCRF catalyst as well, where applicable.

### Diesel Oxidation Catalyst

Systems of the present invention may include one or more diesel oxidation catalysts. Oxidation catalysts, and in particular diesel oxidation catalysts (DOCS), are well-known in the art. Oxidation catalysts are designed to oxidize CO to CO₂ and gas phase hydrocarbons (HC) and an organic fraction of diesel particulates (soluble organic fraction) to CO₂ and H₂O. Typical oxidation catalysts include platinum and optionally also palladium on a high surface area inorganic oxide support, such as alumina, silica-alumina and a zeolite.

### NOx Storage Catalyst

Systems of the present invention may include one or more NOx storage catalysts. NOx storage catalysts may include devices that adsorb, release, and/or reduce NOx according to certain conditions, generally dependent on temperature and/or rich/lean exhaust conditions. NOx storage catalysts may include, for example, passive NOx adsorbers, cold start catalysts, NOx traps, and the like.

### Passive NOx Adsorber

Systems of the present invention may include one or more passive NOx adsorbers. A passive NOₓadsorber is a device that is effective to adsorb NOₓ at or below a low temperature and release the adsorbed NOₓ at temperatures above the low temperature. A passive NOₓ adsorber may comprise a noble metal and a small pore molecular sieve. The noble metal is preferably palladium, platinum, rhodium, gold, silver, iridium, ruthenium, osmium, or mixtures thereof. Preferably, the low temperature is about 200° C., about 250° C., or between about 200° C. to about 250° C. An example of a suitable passive NOx adsorber is described in U.S. Patent Publication No. 20150158019, which is incorporated by reference herein in its entirety.

The small pore molecular sieve may be any natural or a synthetic molecular sieve, including zeolites, and is preferably composed of aluminum, silicon, and/or phosphorus. The molecular sieves typically have a three-dimensional arrangement of SiO₄, AlO₄, and/or PO₄that are joined by the sharing of oxygen atoms, but may also be two-dimensional structures as well. The molecular sieve frameworks are typically anionic, which are counterbalanced by charge compensating cations, typically alkali and alkaline earth elements (e.g., Na, K, Mg, Ca, Sr, and Ba), ammonium ions, and also protons. Other metals (e.g., Fe, Ti, and Ga) may be incorporated into the framework of the small pore molecular sieve to produce a metal-incorporated molecular sieve.

Preferably, the small pore molecular sieve is selected from an aluminosilicate molecular sieve, a metal-substituted aluminosilicate molecular sieve, an aluminophosphate molecular sieve, or a metal-substituted aluminophosphate molecular sieve. More preferably, the small pore molecular sieve is a molecular sieve having the Framework Type of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, and ZON, as well as mixtures or intergrowths of any two or more. Particularly preferred intergrowths of the small pore molecular sieves include KFI-SIV, ITE-RTH, AEW-UEI, AEI-CHA, and AEI-SAV. Most preferably, the small pore molecular sieve is AEI or CHA, or an AEI-CHA intergrowth.

A suitable passive NOₓadsorber may be prepared by any known means. For instance, the noble metal may be added to the small pore molecular sieve to form the passive NOₓadsorber by any known means. For example, a noble metal compound (such as palladium nitrate) may be supported on the molecular sieve by impregnation, adsorption, ion-exchange, incipient wetness, precipitation, or the like.

Other metals may also be added to the passive NOₓ adsorber. Preferably, some of the noble metal (more than 1 percent of the total noble metal added) in the passive NOₓ adsorber is located inside the pores of the small pore molecular sieve. More preferably, more than 5 percent of the total amount of noble metal is located inside the pores of the small pore molecular sieve; and even more preferably may be greater than 10 percent or greater than 25% or greater than 50 percent of the total amount of noble metal that is located inside the pores of the small pore molecular sieve.

Preferably, the passive NOₓadsorber further comprises a flow-through substrate or filter substrate. The passive NOₓ adsorber is coated onto the flow-through or filter substrate, and preferably deposited on the flow-through or filter substrate using a washcoat procedure to produce a passive NOₓ adsorber system.

### Cold Start Catalyst

Systems of the present invention may include one or more cold start catalysts. A cold start catalyst is a device that is effective to adsorb NOₓ and hydrocarbons (HC) at or below a low temperature and to convert and release the adsorbed NOₓ and HC at temperatures above the low temperature. Preferably, the low temperature is about 200° C., about 250° C., or between about 200° C. to about 250° C. An example of a suitable cold start catalyst is described in WO 2015085300, which is incorporated by reference herein in its entirety.

A cold start catalyst may comprise a molecular sieve catalyst and a supported platinum group metal catalyst. The molecular sieve catalyst may include or consist essentially of a noble metal and a molecular sieve. The supported platinum group metal catalyst comprises one or more platinum group metals and one or more inorganic oxide carriers. The noble metal is preferably palladium, platinum, rhodium, gold, silver, iridium, ruthenium, osmium, or mixtures thereof.

The molecular sieve may be any natural or a synthetic molecular sieve, including zeolites, and is preferably composed of aluminum, silicon, and/or phosphorus. The molecular sieves typically have a three-dimensional arrangement of SiO₄, AlO₄, and/or PO₄ that are joined by the sharing of oxygen atoms, but may also be two-dimensional structures as well. The molecular sieve frameworks are typically anionic, which are counterbalanced by charge compensating cations, typically alkali and alkaline earth elements (e.g., Na, K, Mg, Ca, Sr, and Ba), ammonium ions, and also protons.

The molecular sieve may preferably be a small pore molecular sieve having a maximum ring size of eight tetrahedral atoms, a medium pore molecular sieve having a maximum ring size of ten tetrahedral atoms, or a large pore molecular sieve having a maximum ring size of twelve tetrahedral atoms. More preferably, the molecular sieve has a framework structure of AEI, MFI, EMT, ERI, MOR, FER, BEA, FAU, CHA, LEV, MWW, CON, EUO, or mixtures thereof.

The supported platinum group metal catalyst comprises one or more platinum group metals (“PGM”) and one or more inorganic oxide carriers. The PGM may be platinum, palladium, rhodium, iridium, or combinations thereof, and most preferably platinum and/or palladium. The inorganic oxide carriers most commonly include oxides of Groups 2, 3, 4, 5, 13 and 14 elements. Useful inorganic oxide carriers preferably have surface areas in the range 10 to 700 mVg, pore volumes in the range 0.1 to 4 mL/g, and pore diameters from about 10 to 1000 Angstroms. The inorganic oxide carrier is preferably alumina, silica, titania, zirconia, ceria, niobia, tantalum oxides, molybdenum oxides, tungsten oxides, or mixed oxides or composite oxides of any two or more thereof, e.g. silica-alumina, ceria-zirconia or alumina-ceria-zirconia. Alumina and ceria are particularly preferred.

The supported platinum group metal catalyst may be prepared by any known means. Preferably, the one or more platinum group metals are loaded onto the one or more inorganic oxides by any known means to form the supported PGM catalyst, the manner of addition is not considered to be particularly critical. For example, a platinum compound (such as platinum nitrate) may be supported on an inorganic oxide by impregnation, adsorption, ion- exchange, incipient wetness, precipitation, or the like. Other metals, such as iron, manganese, cobalt and barium, may also be added to the supported PGM catalyst.

A cold start catalyst of the present invention may be prepared by processes well known in the art. The molecular sieve catalyst and the supported platinum group metal catalyst may be physically mixed to produce the cold start catalyst. Preferably, the cold start catalyst further comprises a flow-through substrate or filter substrate. In one embodiment, the molecular sieve catalyst and the supported platinum group metal catalyst are coated onto the flow-through or filter substrate, and preferably deposited on the flow-through or filter substrate using a washcoat procedure to produce a cold start catalyst system.

### NOx Traps

Systems of the present invention may include one or more NOx traps. NOx traps are devices that adsorb NOx under lean exhaust conditions, release the adsorbed NOx under rich conditions, and reduce the released NOx to form N₂.

A NOx trap of embodiments of the present invention may include a NOx adsorbent for the storage of NOx and an oxidation/reduction catalyst. Typically, nitric oxide reacts with oxygen to produce NO₂ in the presence of the oxidation catalyst. Second, the NO₂ is adsorbed by the NOx adsorbent in the form of an inorganic nitrate (for example, BaO or BaCO₃ is converted to Ba(NO₃)₂ on the NOx adsorbent). Lastly, when the engine runs under rich conditions, the stored inorganic nitrates decompose to form NO or NO₂ which are then reduced to form N₂ by reaction with carbon monoxide, hydrogen, and/or hydrocarbons (or via NHₓ or NCO intermediates) in the presence of the reduction catalyst. Typically, the nitrogen oxides are converted to nitrogen, carbon dioxide, and water in the presence of heat, carbon monoxide, and hydrocarbons in the exhaust stream.

The NOx adsorbent component is preferably an alkaline earth metal (such as Ba, Ca, Sr, and Mg), an alkali metal (such as K, Na, Li, and Cs), a rare earth metal (such as La, Y, Pr, and Nd), or combinations thereof. These metals are typically found in the form of oxides. The oxidation/reduction catalyst may include one or more noble metals. Suitable noble metals may include platinum, palladium, and/or rhodium. Preferably, platinum is included to perform the oxidation function and rhodium is included to perform the reduction function. The oxidation/reduction catalyst and the NOx adsorbent may be loaded on a support material such as an inorganic oxide for use in the exhaust system.

### Ammonia Oxidation Catalyst

Systems of the present invention may include one or more ammonia oxidation catalysts, also called an ammonia slip catalyst (“ASC”). One or more ASC may be included downstream from an SCR catalyst, to oxidize excess ammonia and prevent it from being released to the atmosphere. In certain embodiments, the ammonia oxidation catalyst material may be selected to favor the oxidation of ammonia instead of the formation of NOₓ or N₂O. Preferred catalyst materials include platinum, palladium, or a combination thereof, with platinum or a platinum/palladium combination being preferred. Preferably, the ammonia oxidation catalyst comprises platinum and/or palladium supported on a metal oxide. Preferably, the catalyst is disposed on a high surface area support, including but not limited to alumina.

### Three-Way Catalysts

Systems of the present invention may include one or more three-way catalysts (TWCs). TWCs are typically used in gasoline engines under stoichiometric conditions in order to convert NOₓ to N₂, carbon monoxide to CO₂, and hydrocarbons to CO₂ and H₂O on a single device.

### Filters

Systems of the present invention may include one or more particulate filters. Particulate filters are devices that reduce particulates from the exhaust of internal combustion engines. Particulate filters include catalyzed particulate filters and bare (non-catalyzed) particulate filters. Catalyzed particulate filters, also called catalyzed soot filters, (for diesel and gasoline applications) include metal and metal oxide components (such as Pt, Pd, Fe, Mn, Cu, and ceria) to oxidize hydrocarbons and carbon monoxide in addition to destroying soot trapped by the filter.

### Substrate

Catalysts and adsorbers of the present invention may each further comprise a flow-through substrate or filter substrate. In one embodiment, the catalyst/adsorber may be coated onto the flow-through or filter substrate, and preferably deposited on the flow-through or filter substrate using a washcoat procedure.

The combination of an SCR catalyst and a filter is known as a selective catalytic reduction filter (SCRF catalyst). An SCRF catalyst is a single-substrate device that combines the functionality of an SCR and particulate filter, and is suitable for embodiments of the present invention as desired. Description of and references to the SCR catalyst throughout this application are understood to include the SCRF catalyst as well, where applicable.

The flow-through or filter substrate is a substrate that is capable of containing catalyst/adsorber components. The substrate is preferably a ceramic substrate or a metallic substrate. The ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates, metallo aluminosilicates (such as cordierite and spudomene), or a mixture or mixed oxide of any two or more thereof. Cordierite, a magnesium aluminosilicate, and silicon carbide are particularly preferred.

The metallic substrates may be made of any suitable metal, and in particular heat-resistant metals and metal alloys such as titanium and stainless steel as well as ferritic alloys containing iron, nickel, chromium, and/or aluminum in addition to other trace metals.

The flow-through substrate is preferably a flow-through monolith having a honeycomb structure with many small, parallel thin-walled channels running axially through the substrate and extending throughout from an inlet or an outlet of the substrate. The channel cross-section of the substrate may be any shape, but is preferably square, sinusoidal, triangular, rectangular, hexagonal, trapezoidal, circular, or oval. The flow-through substrate may also be high porosity which allows the catalyst to penetrate into the substrate walls.

The filter substrate is preferably a wall-flow monolith filter. The channels of a wall-flow filter are alternately blocked, which allow the exhaust gas stream to enter a channel from the inlet, then flow through the channel walls, and exit the filter from a different channel leading to the outlet. Particulates in the exhaust gas stream are thus trapped in the filter.

The catalyst/adsorber may be added to the flow-through or filter substrate by any known means, such as a washcoat procedure.

### Reductant/Urea Injector

Systems of the present invention may include one or more means for introducing a nitrogenous reductant into the exhaust system upstream of the SCR catalyst. It may be preferred that the means for introducing a nitrogenous reductant into the exhaust system is directly upstream of an SCR catalyst (e.g. there is no intervening catalyst between the means for introducing a nitrogenous reductant and the SCR catalyst).

The reductant is added to the flowing exhaust gas by any suitable means for introducing the reductant into the exhaust gas. Suitable means include an injector, sprayer, or feeder. Such means are well known in the art.

The nitrogenous reductant for use in the system can be ammonia per se, hydrazine, or a compound decomposable into ammonia such as urea, ammonium carbonate, ammonium carbamate, ammonium hydrogen carbonate, and ammonium formate. Urea is particularly preferred.

The exhaust system may also comprise a means for controlling the introduction of reductant into the exhaust gas in order to reduce NOx therein. Preferred control means may include an electronic control unit, optionally an engine control unit, and may additionally comprise a NOx sensor located downstream of the NO reduction catalyst.

In some embodiments, the amount of ammonia or compound decomposable to ammonia which is added to the gas stream is selected so that the exhaust gas stream passing over the V-SCR catalyst has an NH₃/NOx ratio of less than 1; about 0.1 to about 0.9; about 0.1 to about 0.8; about 0.1 to about 0.7; about 0.1 to about 0.6; about 0.1 to about 0.5; about 0.2 to about 0.9; about 0.2 to about 0.8; about 0.2 to about 0.7; about 0.2 to about 0.6; about 0.2 to about 0.5; about 0.3 to about 0.8; about 0.3 to about 0.9; or about 0.5 to about 0.9. Such ammonia dosing may prevent NH₃ from slipping over downstream oxidation catalysts creating NOx.

In other embodiments, the amount of ammonia or compound decomposable to ammonia which is added to the gas stream is selected so that the exhaust gas stream passing over the V-SCR catalyst has an NH₃/NOx ratio of about 1.

In other embodiments, the amount of ammonia or compound decomposable to ammonia which is added to the gas stream is selected so that the exhaust gas stream passing over the V-SCR catalyst has an NH₃/NOx ratio of greater than 1; about 1.1 to about 1.9; about 1.2 to about 1.8; about 1.3 to about 1.7; or about 1.4 to about 1.6.

One or more secondary reductant injectors may be included as desired.

### Fuel Injector

Systems of the present invention may include one or more fuel injectors. For example, a system may include a secondary fuel injector upstream of a diesel oxidation catalyst. Any suitable type of fuel injector may be used in systems of the present invention.

### Embodiments/Systems

In some embodiments of the present invention, an exhaust gas purification system may include an upstream section and a downstream section. The upstream section may include at least a feeding device that feeds ammonia or a compound decomposable into ammonia into the exhaust gas stream containing nitrogen oxides, followed by a V-SCR catalyst.

The upstream section may comprise a low temperature zone. Specifically, the upstream section may have temperatures of about 150° C. to about 400° C.; about 150° C. to about 350° C.; about 200° C. to about 400° C.; about 200° C. to about 350° C.; about 150° C. to about 300° C.; about 150° C. to about 250° C.; or about 200° C. to about 300° C. In some embodiments, the upstream section comprises a low temperature zone relative to the temperature of the downstream section. The temperatures of the high and low temperature zone refer to the temperatures of the exhaust once the engine has warmed up. The downstream section may comprise a high temperature zone, particularly in relation to the upstream section. The downstream section may have temperatures of about 200° C. to about 400° C.; about 150° C. to about 400° C.; about 150° C. to about 500° C.; about 150° C. to about 450° C.; about 200° C. to about 450° C.; about 200° C. to about 500° C.; about 250° C. to about 400° C.; about 250° C. to about 450° C.; about 250° C. to about 500° C.; about 300° C. to about 400° C.; about 300° C. to about 450° C.; about 300° C. to about 500° C.; or about 350° C. to about 500° C.

A turbocharger may be included downstream of the feeding device and/or the V-SCR catalyst. The turbocharger may provide mixing functionality, which may be particularly useful to disperse the ammonia or compound decomposable into ammonia within the exhaust gas stream. Additionally, the turbocharger may provide a temperature drop of about 80-100° C. as the exhaust gas stream passes through it. This temperature drop associated with the turbocharger may result in the low temperature zone for the upstream section of a system. Configuring a system with the turbocharger upstream of the V-SCR catalyst may allow for the benefits of having the V-SCR catalyst operate in the low temperature zone, as described herein. However, depending on the configuration, in some embodiments temperatures in front of the turbocharger will still be relatively low and therefore a V-SCR catalyst located upstream of a turbocharger may also be operating in a low temperature zone.

The V-SCR catalyst may be coupled with additional components, as desired. For example, the V-SCR catalyst may be coupled with a hydrolysis catalyst, where the hydrolysis catalyst is located upstream of the V-SCR catalyst. The V-SCR catalyst may be coupled with an ammonia slip catalyst, where the ammonia slip catalyst is located downstream of the V-SCR catalyst. The term “coupled” as used herein is understood to mean that the components may be combined within the same substrate or may be installed separately but closely positioned.

The components in the downstream section may be referred to as the downstream system. An exothermic catalyst such as a diesel oxidation catalyst or an ammonia slip catalyst may increase the temperature and act as the figurative boundary marking the beginning of the downstream section. The exothermic catalyst may allow the system to maintain a low temperature zone upstream of a high temperature zone, thereby enabling the benefits associated with this system configuration as described herein. In some embodiments, an exothermic catalyst may provide a temperature increase of about 50° C. to about 150° C.; about 50° C. to about 100° C.; or about 100° C. to about 150° C. Additionally, the exothermic catalyst provides the benefit of raising the temperature and thereby regenerating a downstream filter.

The downstream system may include one or more of a diesel oxidation catalyst, an ammonia slip catalyst, a particle filter such as a catalyzed soot filter, a NOx storage catalyst such as a NOx adsorber catalyst, a three-way catalyst, an injector for ammonia or a compound decomposable to ammonia, and/or an SCR catalyst. The downstream system may include more than one of each type of component, if desired.

The downstream system, including for example a diesel oxidation catalyst, may be effective for removing pollutants from the exhaust gas in a temperature range of about 150° C. to about 400° C.; about 150° C. to about 500° C.; about 200° C. to about 400° C.; about 250° C. to about 400° C.; about 250° C. to about 500° C.; about 300° C. to about 400° C.; or about 300° C. to about 500° C. A system may include a secondary fuel injector upstream of a diesel oxidation catalyst.

In one embodiment, the downstream system includes, in order, an ammonia slip catalyst, a diesel oxidation catalyst, a catalyzed soot filter, and a selective catalytic reduction catalyst. In one embodiment, the downstream system includes, in order, an ammonia slip catalyst, a diesel oxidation catalyst, an SCRF, and a selective catalytic reduction catalyst.

A system may include a cold start catalyst downstream of the V-SCR catalyst. The cold start catalyst may comprise, for example, a passive NOx adsorber which may include zeolite and Pd. When the cold start catalyst comprises a passive NOx adsorber, the cold start catalyst may be effective to adsorb NOx at or below a low temperature and to release the adsorbed NOx at temperatures above the low temperature. The cold start catalyst may also be formulated to adsorb NOx and hydrocarbons at or below a low temperature and to convert and release the adsorbed NOx and hydrocarbons above a low temperature. In some embodiments, the low temperature is about 200° C.; about 150° C.; about 250° C.; about 300° C.; about 150° C. to about 250° C.; or about 175° C. to about 225° C. In some embodiments, the cold start catalyst is located downstream of the V-SCR catalyst but within the upstream section of a system. The cold start catalyst may be located in a low temperature zone. In some embodiments, the cold start catalyst is located downstream of the V-SCR catalyst within the downstream section of the system. The cold start catalyst may be located in a high temperature zone. In some embodiments, a system includes a V-SCR catalyst followed by a cold start catalyst, followed by a downstream system including a diesel oxidation catalyst.

Exemplary embodiments of systems of the present invention may include, but are not limited to:
[Reductant injection]-[Turbo]-[V-SCR][Optional ASC]-[Fuel injector]-[Optional ASC][DOC]-[CSF]
[Reductant injection]-[V-SCR]-[DOC or NOx storage catalyst]-[Reductant injection]-[SCR]-[Fuel injector]-[DOC]-[CSF]
[Reductant injection]-[V-SCR]-[ASC]-[DOC]-[Reductant injection]-[SCRF]-[SCR]-[Optional ASC]
[Reductant injection]-[V-SCR]-[ASC]-[DOC or NOx storage catalyst]-[CSF]-[Reductant injection]-[SCR]-[Optional ASC]
[Reductant injection]-[V-SCR]-[ASC]-[Fuel injector]-[DOC]-[CSF]-[Reductant injection]-[SCR]-[Optional ASC]
[Reductant injection]-[V-SCR]-[Fuel injector]-[ASC]-[DOC]-[CSF]-[Reductant injection]-[SCR]-[Optional ASC]
[Reductant injection]-[V-SCR]-[Fuel injector]-[DOC or NOx storage catalyst]-[Reductant injection]-[SCRF]-[SCR/ASC]

### Methods

Methods of the present invention may include treatment of diesel engine exhaust gases in an exhaust system containing nitrogen oxides, comprising adding ammonia or a compound decomposable to ammonia into the exhaust gas stream containing nitrogen oxides; passing the exhaust gas stream containing nitrogen oxides over a selective catalytic reduction catalyst comprising vanadium (V-SCR) which catalyzes the nitrogen oxides with ammonia in a temperature range of about 150° C. to about 400° C.; and passing the exhaust gas through a downstream system comprising a diesel oxidation catalyst. The V-SCR catalyst may achieve a NOx conversion of about 60% to about 80%.

Methods of the present invention may include a treatment of diesel engine exhaust gases in an exhaust system containing nitrogen oxides, comprising adding ammonia or a compound decomposable to ammonia into the exhaust gas stream containing nitrogen oxides; passing the exhaust gas stream containing nitrogen oxides over a selective catalytic reduction catalyst comprising vanadium (V-SCR catalyst) which catalyzes the nitrogen oxides with ammonia in a temperature range of about 150° C. to about 400° C.; and passing the exhaust stream over a NOx storage catalyst such as a cold start catalyst. The V-SCR catalyst may achieve a NOx conversion of about 60% to about 80%.

### Benefits

Systems and methods of the present invention may provide benefits related to N₂O emissions, particularly during cold starts and in cold exhaust gas systems. Specifically, use of a V-SCR catalyst as described in embodiments herein may function particularly well for a high engine out NO₂ system, as the V-SCR catalyst catalyzes nitrous oxides at NO₂ fractions greater than 40% and at temperature ranges covering low temperature. These characteristics are desirable as they help to prevent NO₂ slip to a downstream diesel oxidation catalyst (“DOC”) under conditions where the downstream catalyst would be active for HC-SCR. Surprisingly, it has been found that V-based formulations achieve higher conversions under these conditions (high-NO₂ on-road engine out conditions) than traditional state of the art Fe or Cu SCR catalysts.

The V-SCR catalyst may catalyze nitrous oxides with ammonia in a temperature range of about 150° C. to about 450° C.; about 150° C. to about 400° C.; about 150° C. to about 350° C.; about 150° C. to about 300° C.; about 150° C. to about 250° C.; about 200° C. to about 400° C.; about 200° C. to about 350° C.; or about 200° C. to about 300° C. The V-SCR catalyst may catalyze nitrous oxides with ammonia at an NO₂/NOx ratio of about 0.05 to about 0.8; about 0.05 to about 0.9; about 0.07 to about 0.8; about 0.07 to about 0.9; about 0.1 to about 0.8;about 0.1 to about 0.9; about 0.2 to about 0.8; about 0.2 to about 0.9; about 0.3 to about 0.8; about 0.3 to about 0.9; about 0.3 to about 0.7; about 0.3 to about 0.6; about 0.3 to about 0.5; about 0.5 to about 0.9; about 0.4 to about 0.9; about 0.4 to about 0.8; about 0.4 to about 0.7; about 0.4 to about 0.6; about 0.5 to about 0.8; about 0.5 to about 0.7; about 0.5 to about 0.6; or about 0.6 to about 0.8.

At such NO2/NOx ratios and temperatures, the V-SCR catalyst may provide NOx conversion of at least 60%; at least 65%; at least 70%; at least 75%; about 60% to about 80%; about 65% to about 75%; about 65% to about 80%; about 70% to about 75%; or about 70% to about 80%. These conversions under high NO₂ conditions are surprisingly higher than traditional state of the art Fe or Cu SCR catalysts.

By including a V-SCR catalyst in the upstream section of the exhaust system, system configurations of the present invention may provide the benefits of the V-SCR catalyst described herein, while avoiding issues associated with vanadium catalysts in higher temperatures. Such benefits may be associated with the unconventional set-up of including a low temperature zone followed by a high temperature zone. The V-SCR catalyst in this system may demonstrate a resistance to sulfur poisoning, as well as the partial oxidation of hydrocarbons in the exhaust system. The partial oxidation of hydrocarbons to CO may provide a further benefit when combined with a NOx storage catalyst such as a cold start catalyst, as the CO provides an increase to the NOx storage capacity of the NOx storage catalyst. Further, the upstream V-SCR catalyst configuration allows NOx conversion earlier in the cycle (i.e. at lower temperatures) because the V-SCR catalyst will heat up before the downstream components.

### Examples

NOx conversion of several catalysts was measured at various NO₂/NOx ratios. The tested catalysts were:
Von TiO₂
V on TiO₂ with added zeolite component
Cu on AEI
Fe on BEA

The tests evaluated fresh performance of vanadium and iron based SCR formulations at 150° C. To act as a Cu reference, high Cu loaded Cu/AEI was used and compared to extruded vanadium catalysts and coated iron formulations. The catalysts were evaluated fresh at a space velocity of 50,000 h⁻¹, an ammonia to NOx ratio of 1 and with no NO₂ in the feed.

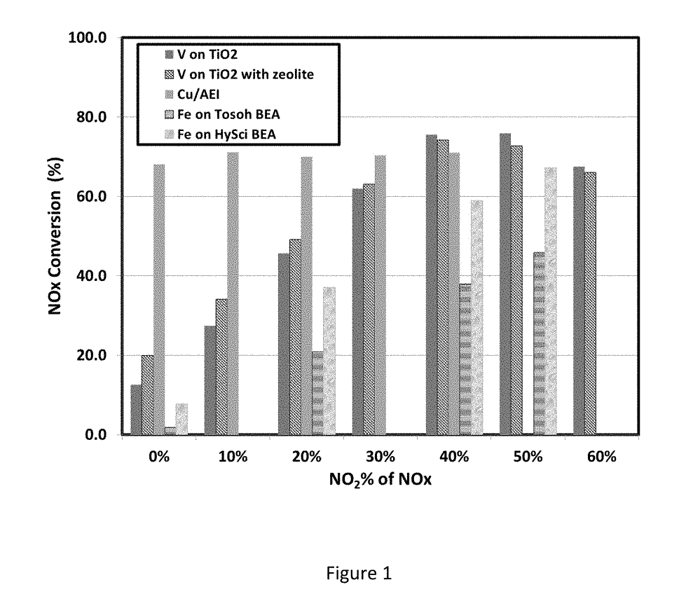

The results are shown in FIG. 1. The data demonstrates that at a NO₂/NOx ratio of 0.4 and greater, the vanadium catalysts provide superior NOx conversion, while at the higher ratios, the other catalysts fail completely. As percent NO₂ is increased, the conversion of vanadium and iron based catalyst continue to increase up to a maximum conversion for the vanadium formulations of 75% at 40% NO₂. The Cu catalyst shows little increase with increasing NO₂.

1. An exhaust gas purification system for lowering the content of impurities in a lean exhaust gas of an internal combustion engine comprising, in combination and in order as follows:
a. a feeding device that feeds ammonia or a compound decomposable to ammonia into an exhaust gas stream containing nitrogen oxides;
b. a selective catalytic reduction catalyst comprising vanadium (V-SCR catalyst) which catalyzes the nitrogen oxides with ammonia in a temperature range of about 150° C. to about 400° C. and at an NO₂/NOₓ ratio of about 0.3 to about 0.9; and
c. a downstream system comprising a diesel oxidation catalyst.

2. The exhaust gas purification system of claim 1, wherein the V-SCR catalyst is coupled with a hydrolysis catalyst located upstream of the V-SCR catalyst.

3. (canceled)

4. (canceled)

5. (canceled)

6. The exhaust gas purification system of claim 1, wherein the downstream system is effective for removing pollutants from the exhaust gas in a temperature range of about 150° C. to about 400° C.

7. The exhaust gas purification system of claim 1, wherein the diesel oxidation catalyst oxidizes pollutants from the exhaust gas in a temperature range of about 150° C. to about 400° C.

8. (canceled)

9. (canceled)

10. The exhaust gas purification system of claim 1, wherein the downstream system comprises a catalyzed soot filter.

11. The exhaust gas purification system of claim 1, wherein the downstream system comprises, in order, an ammonia slip catalyst, a diesel oxidation catalyst, a catalyzed soot filter, and a selective catalytic reduction catalyst.

12. The exhaust gas purification system of claim 1, wherein the downstream system comprises, in order, an ammonia slip catalyst, a diesel oxidation catalyst, an SCRF, and a selective catalytic reduction catalyst.

13. An exhaust gas purification system for lowering the content of impurities in a lean exhaust gas of an internal combustion engine, the exhaust gas having an NO₂/NOₓ ratio of about 0.3 to about 0.9, comprising:
a. a feeding device that feeds ammonia or a compound decomposable to ammonia into an exhaust gas stream containing nitrogen oxides;
b. a selective catalytic reduction catalyst comprising vanadium (V-SCR catalyst);
c. a turbocharger downstream of the feeding device and/or the V-SCR catalyst;
d. a secondary fuel injector; and
e. a downstream system comprising a diesel oxidation catalyst.

14. (canceled)

15. The exhaust gas purification system of claim 13, wherein the downstream system comprises a catalyzed soot filter.

16. The exhaust gas purification system of claim 13, wherein the downstream system comprises, in order, an ammonia slip catalyst, a diesel oxidation catalyst, a catalyzed soot filter, and a selective catalytic reduction catalyst.

17. The exhaust gas purification system of claim 13, wherein the downstream system comprises, in order, an ammonia slip catalyst, a diesel oxidation catalyst, an SCRF, and a selective catalytic reduction catalyst.

18. The exhaust gas purification system of claim 13, wherein the downstream system is effective for removing pollutants from the exhaust gas in a temperature range of about 150° C. to about 400° C.

19. The exhaust gas purification system of claim 13, wherein the diesel oxidation catalyst oxidizes pollutants from the exhaust gas in a temperature range of about 150° C. to about 400° C.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A method of treatment of diesel engine exhaust gases in an exhaust system containing nitrogen oxides, comprising:
a. adding ammonia or a compound decomposable to ammonia into the exhaust gas stream containing nitrogen oxides;
b. passing the exhaust gas stream containing nitrogen oxides, with an NO₂/NOₓ ratio of about 0.3 to about 0.9, over a selective catalytic reduction catalyst comprising vanadium (V-SCR catalyst) which catalyzes the nitrogen oxides with ammonia in a temperature range of about 150° C. to about 400° C.; and
c. passing the exhaust gas through a downstream system comprising a diesel oxidation catalyst.

48. (canceled)

49. (canceled)

50. The method of claim 47, wherein the downstream system removes pollutants from the exhaust gas in a temperature range of about 150° C. to about 400° C.

51. The method of claim 47, wherein the diesel oxidation catalyst oxidizes pollutants from the exhaust gas in a temperature range of about 150° C. to about 400° C.

52. (canceled)

53. (canceled)

54. The method of claim 47, wherein the downstream system comprises a catalyzed soot filter.

55. (canceled)

56. (canceled)

57. The method of claim 47, wherein the amount of ammonia or of a compound decomposable to ammonia added to the exhaust gas stream in (a) is selected so that the exhaust gas stream has an NH3/NOx ratio of about 0.1 to about 0.7.

58. The method of claim 47, wherein the V-SCR catalyst is coupled with a hydrolysis catalyst located upstream of the V-SCR catalyst.

59. (canceled)

60. The method of claim 47, wherein the V-SCR catalyst achieves a NOx conversion of about 60% to about 80%.

61. (canceled)

62. (canceled)

63. (canceled)

64. (canceled)

65. (canceled)

66. (canceled)

67. (canceled)

68. (canceled)

69. (canceled)

70. (Canceled)

71. (Canceled)

72. (Canceled)

73. (Canceled)

74. (Canceled)

75. (Canceled)
